(19) United States
(12) Patent Application Publication
(10) Pub. No.: US 2015/0348213 A1
(43) Pub. Date: Dec. 3, 2015

(54) Computer based system for spend analysis solution through strategies for mining spend information

(71) Applicants: BIKASH MOHANTY, MUMBAI (IN); ASHISH JHA, MUMBAI (IN)

(72) Inventors: BIKASH MOHANTY, MUMBAI (IN); ASHISH JHA, MUMBAI (IN)

(21) Appl. No.: 14/790,751

(22) Filed: Jul. 2, 2015

Related U.S. Application Data
(63) Continuation-in-part of application No. 13/423,285, filed on Mar. 19, 2012.

(30) Foreign Application Priority Data
Dec. 28, 2011 (IN) 3680/MUM/2011

(51) Int. Cl. G06Q 40/00

(52) U.S. Cl. CPC G06Q 40/12

(57) ABSTRACT

A computer based system for spend analysis solution through strategies for mining spend information, the system comprises a processor unit; and a computer readable medium storing instructions executable by the processor unit comprising classification system adapted to classify spend data in accordance with pre-determined parameters of classification; categorization system adapted to categorize classified spend data based on pre-defined parameters; input system adapted to input pre-defined fields in relation to category of spend data, supplier information, payment terms, contracts or contract terms, and other pre-defined dimensions; saving strategy analysis engine adapted to analyze classified and categorized spend data based on pre-determined strategies, the saving strategy analysis engine further comprising category based saving strategy analysis engine adapted to output saving strategy per identified category inputs; and supplier based saving strategy analysis engine adapted to output saving strategy per identified supplier inputs.

### CROSS REFERENCE TO RELATED APPLICATIONS

The present invention is a continuation in part of U.S. patent application Ser. No. 13/423,285, filed Mar. 19, 2012, pending, and claims priority to the Indian Patent Application Serial No. 3680/MUM/2011, filed Dec. 28, 2011, the entire specifications of both of which are expressly herein incorporated by reference.

### FIELD OF THE INVENTION

The present invention relates generally to the field of information and computation systems, more particularly to the field of information and computation systems in relation to procurement performance, and still more particularly to spend analysis solutions through strategies for mining spend information.

### BACKGROUND OF THE INVENTION

In all organizations, spend data is the data in relation to all spending activity in the organization. Spend data has a direct correlation with organization turnover, profit percentage, and the like. Analysis of spend data is important to understand organizational needs, redundancies in spend data, and actionable points to curb redundancies.

Purchasing professionals are constantly looking for opportunities to save money. Most of the time, the saving opportunities lie within their organization and can be identified from their spend data.

The major challenges in finding savings opportunities are as follows. Spend data are huge in volume, with no standard strategy available across the organization. U.S. Patent Application Publication No. 2003/0139986 discloses a system and method for tracking spend analysis. The tracking system and method provides a correlation of spend items within the plurality of purchasing categories, such as suppliers, types of goods, and/or business units received from a user. Further, it identifies non-discretionary spend items, thereby analyzing true spend within an organization.

U.S. Patent Application Publication No. 2009/0100017 discloses a computer implemented method for processing spend data, wherein the computer implemented method comprises being responsive to capturing data feeds from one or more clients and a service provider, normalizing spend data contained within the data feeds by mapping the spend data to a common universal taxonomy using a business rule set to form normalized spend data, storing the normalized spend data within an aggregated spend database, running report queries against total aggregated spend data within the aggregated spend database, and posting results of the report queries on a secure web portal for viewing by authorized users.

A patent pending flexible spend tracking tool marketed under the tradename “GEP spend” from The GEP™/Global eProcure is an AI-based spend analysis engine, that is an easy to use Cloud-based tool helping analyses and classification of large volumes of spend data. Further, it works with data from any system, in any file type in any language or character set by cleansing, validating and normalizing the data for complete analysis. Further, it provides insight on where and how to achieve cost savings across the entire spend.

Accordingly, there exists a need for new and improved systems and methods for spend analysis that overcome at least one of the aforementioned problems.

### SUMMARY OF THE INVENTION

An object of the present invention is to provide a system and method to classify spend data. Another object of the present invention is to provide a system and method to analyze spend data. Yet another object of the present invention is to provide a system and method that provides an actionable opportunities report based on classified and analysed spend data.

According to one aspect of the present invention, there is provided a computer based system for spend analysis solution through strategies for mining spend information, wherein the system comprises: a processor unit; and a computer readable medium storing instructions executable by the processor unit comprising: a classification system adapted to classify spend data in accordance with pre-determined parameters of classification; a categorization system adapted to categorize classified spend data based on pre-defined parameters; an input system adapted to input pre-defined fields in relation to category of spend data, supplier information, payment terms, contracts or contract terms, and other pre-defined dimensions; and a saving strategy analysis engine adapted to analyze classified and categorized spend data based on pre-determined strategies, the saving strategy analysis engine adapted to output saving strategy per identified inputs. Typically, the saving strategy engine comprises a supplier consolidation saving strategy formulating system adapted to output savings achieved due to reducing supplier base to top suppliers.

Typically, the saving strategy engine comprises a spend consolidation saving strategy formulating system adapted to output savings achieved due to aggregating demand from different business units.

Typically, the saving strategy engine comprises a contract compliance saving strategy formulating system adapted to output savings achieved by reducing spend from off-contract.

Typically, the saving strategy engine comprises a payment term rationalization strategy formulating system adapted to output savings achieved due to getting the best payment term from each supplier.

Typically, the saving strategy engine comprises a region spread strategy formulating system adapted to provide a region spread strategy and to output elaborates savings achieved due to dealing with global supplier.

Typically, the saving strategy engine comprises a category spread strategy formulating system adapted to output elaborates savings achieved due to dealing with supplier who provide higher number of category.

Typically, the saving strategy engine comprises a payment term strategy formulating system adapted to output elaborate savings achieved by getting best payment term from suppliers.

Typically, the system includes a scope determination system adapted to determine a scope of each of spend data and each of the strategy engines depending upon pre-determined parameters of spend data selection.

Typically, the system includes an unknown category addition system adapted to add categories in relation to spend data.

Typically, the system includes a known category addition system adapted to add categories in relation to spend data.

Typically, the system includes a constraint parameter addition system adapted to add constraints and defined values/threshold of each constraint parameter.

Typically, the system includes a query formulation system adapted to formulate queries on spend data depending upon defined constraints in order to provide results.

Typically, the system includes a report generation system adapted to generate reports of results in correlation with defined constraints and strategies in order to have access and visibility of the saving opportunity strategies.

According to the present invention, there is also provided a computer based method for spend analysis solution through strategies for mining spend information, wherein the method comprises the steps of: classifying spend data in accordance with pre-determined parameters of classification; categorizing classified spend data based on pre-defined parameters; providing input system adapted to input pre-defined fields in relation to category of spend data, supplier information, payment terms, contracts or contract terms, and other pre-defined dimensions; analyzing classified and categorized spend data based on pre-determined strategies, wherein the analyzing method comprises the steps of outputting saving strategy per identified category inputs; and outputting a saving strategy per identified supplier inputs.

Typically, the step of analyzing includes the step of outputting savings achieved due to reducing supplier base to top suppliers.

Typically, the step of analyzing includes the step of outputting savings achieved due to aggregating demand from different business units.

Typically, the step of analyzing includes the step of outputting savings achieved by reducing spend from off-contract.

Typically, the step of analyzing includes the step of outputting savings achieved due to getting the best payment term from each supplier.

Typically, the step of analyzing includes the step of outputting region spread strategy and to output elaborates savings achieved due to dealing with global supplier.

Typically, the step of analyzing includes the step of outputting savings achieved due to dealing with supplier who provide higher number of category.

Typically, the step of analyzing includes the step of outputting savings achieved by getting best payment term from suppliers.

Typically, the method includes the step of determining a scope of each of spend data and each of the strategy engines depending upon pre-determined parameters of classification.

Typically, the method includes the step of adding categories in relation to spend data.

Typically, the method includes the step of adding categories in relation to spend data.

Typically, the method includes the step of adding constraints and defined values/threshold of each constraint parameter.

Typically, the method includes the step of formulating queries on spend data depending upon defined constraints in order to provide results.

Typically, the method includes the step of generating reports of results in correlation with defined constraints and strategies in order to have access and visibility of the saving opportunity strategies.

In accordance with an illustrative embodiment of the present invention, a system for analyzing spend data by applying saving strategies, wherein there is an interconnection of at least one configurable and namable business process element, comprising:

a host computer system;

at least one database component operably associated with the host computer system;

a communication interface for accessing the host computer system from a plurality of remote input/output devices to manage the analysis of the spend data by applying saving strategies for the business process element;

wherein the business process element includes input spend data received from the remote input/output devices;

a processor unit operably associated with the host computer system; and

a computer readable medium storing instructions executable by the processor unit, the computer readable medium comprising:

a classification system adapted to classify the input spend data in accordance with pre-determined parameters of classification and display the results in a classified format;

a categorization system adapted to categorize the classified spend data format based on pre-defined parameters and convert the classified spend data format into a categorized spend data format;

a spend input system adapted to input pre-defined fields in relation to a category of spend data, supplier information, payment terms, contracts or contract terms; and

a saving strategy analysis engine adapted to analyze the classified and categorized spend data format based on pre-determined strategies, wherein the saving strategy analysis engine is further adapted to convert the input of classified and categorized spend data format into an output and depict a saving strategy according to the identified inputs.

For example, the user could manage an element of the system and method for managing spend analysis on the handheld mobile device (e.g., cellular phone, smartphone, PDA, laptop computer, tablet computer, and/or any other like device that is selectively operable to communicate with the host computer system (or component thereof) through a wired and/or wireless connection) for which management needs to be done for.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Embodiments of the present invention are illustrated in the figures of the accompanying drawings. The figures are provided to aid thorough understanding of the invention and are exemplary rather than limiting. Based on the present teachings, person of ordinary skill in the art can contemplate various alternatives, variations and modifications to the illustrated embodiments within the scope of the invention disclosed herein.

The invention will now be described in relation to the accompanying drawings, in which:

FIG. 1 illustrates a schematic manual savings identification process;

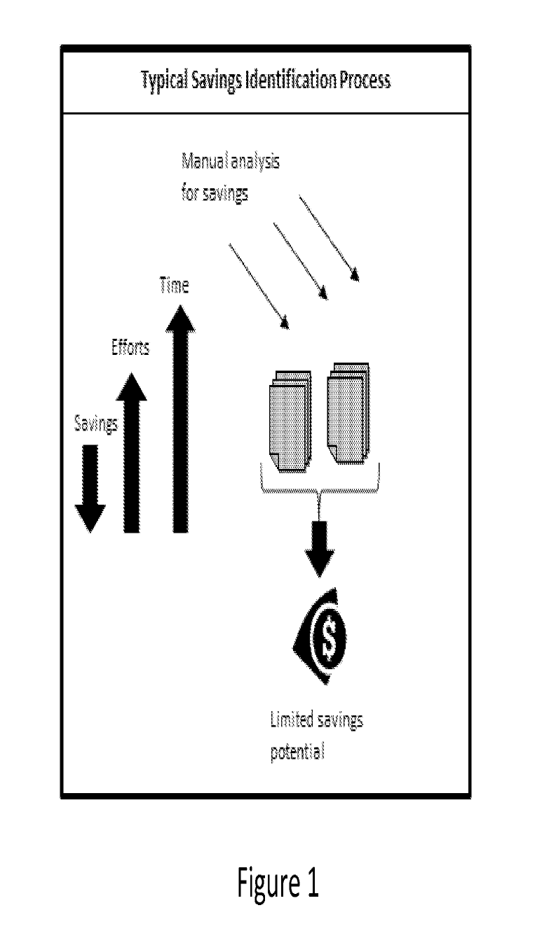

FIG. 2 illustrates a schematic savings identification process;

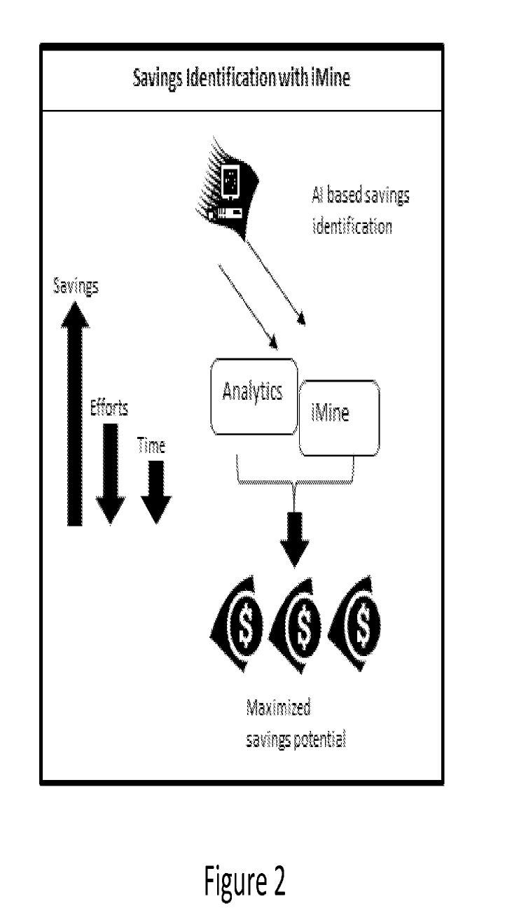

FIG. 3 illustrates a pre-packaged strategy for a savings identification process;

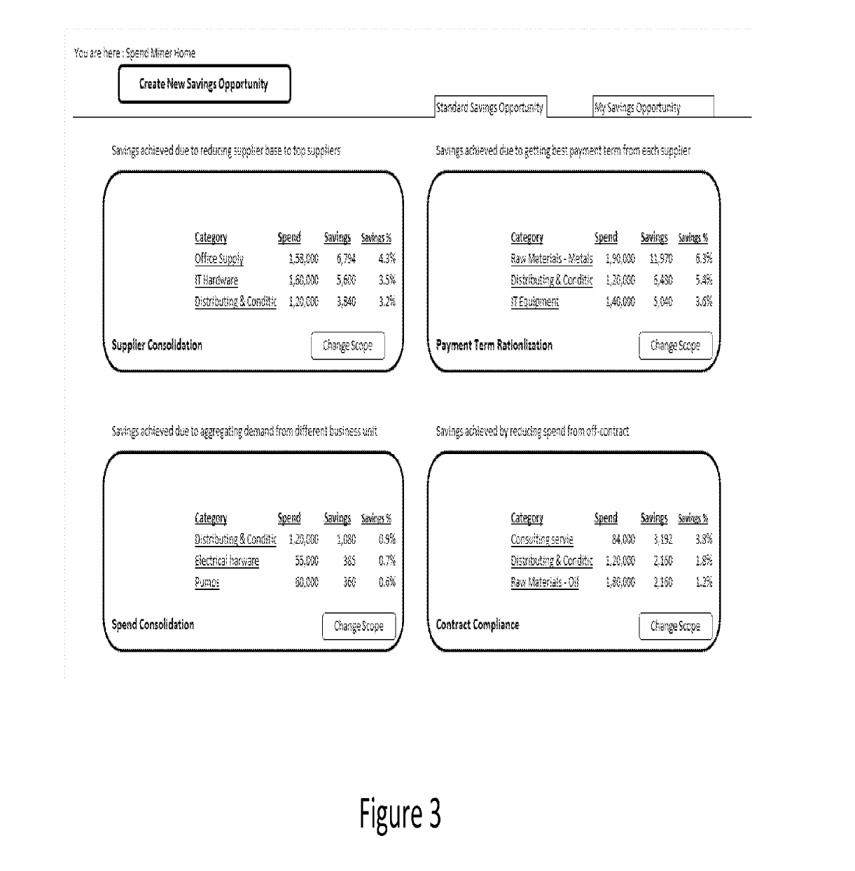

FIG. 4 illustrates an exemplary computer screenshot for addressable spend for an unknown category;

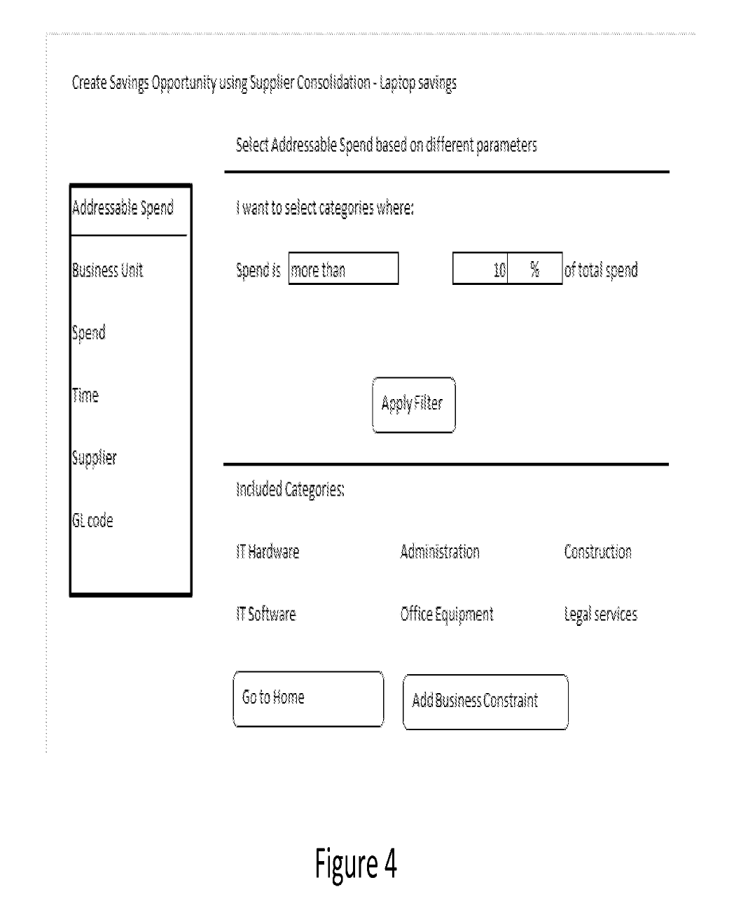

FIG. 5 illustrates an exemplary computer screenshot for addressable spend for a known category;

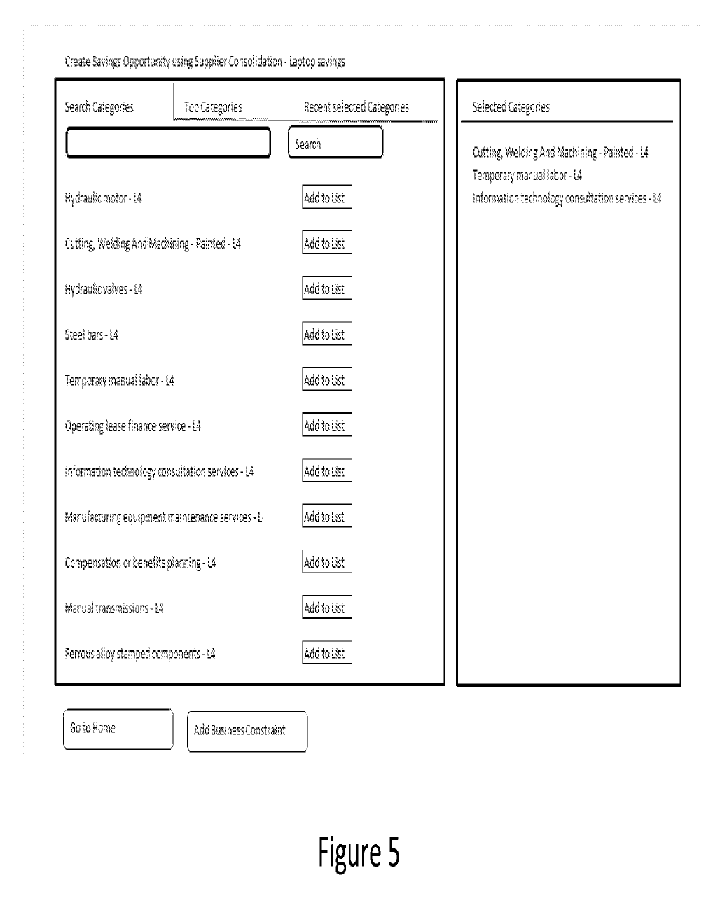

FIG. 6 illustrates an exemplary computer screenshot to define a business constraint;

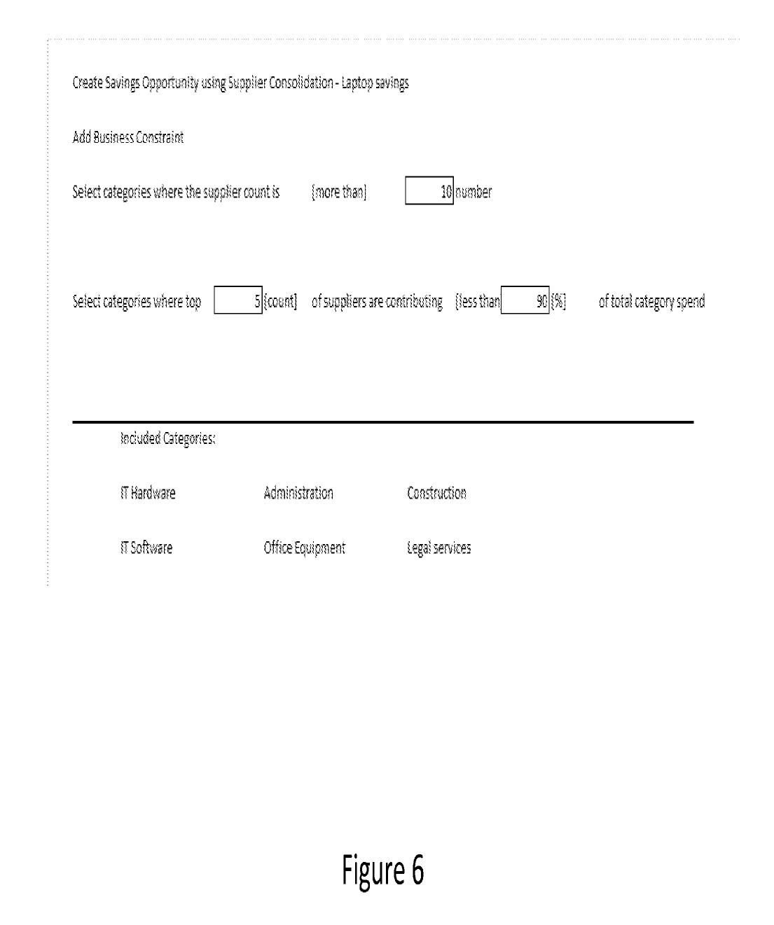

FIG. 7 illustrates a listing of saving opportunities created and scheduled; and

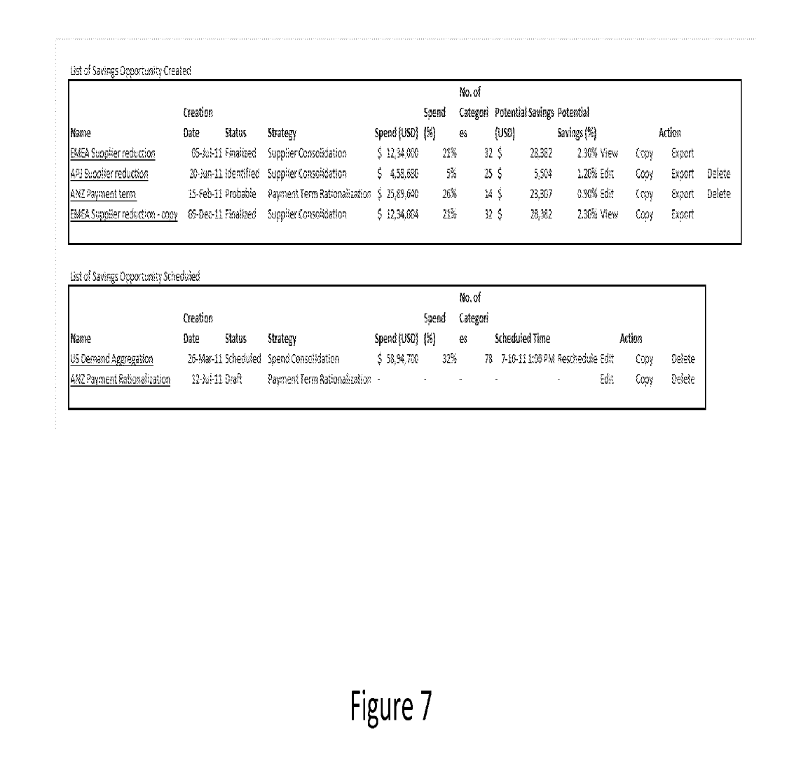

FIG. 8 illustrates a report for savings opportunities.

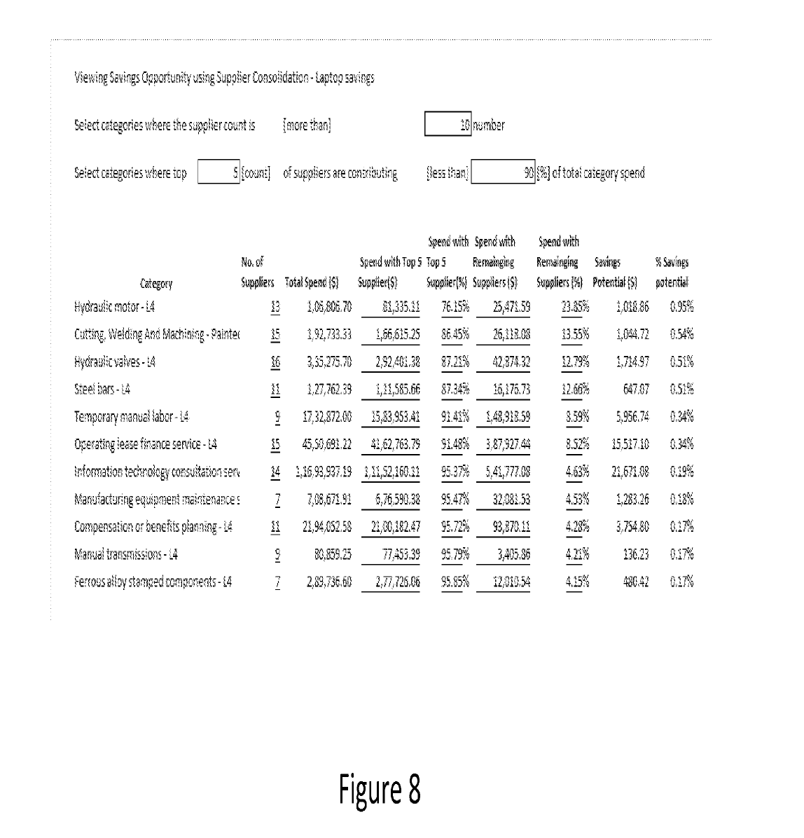

### DETAILED DESCRIPTION OF THE INVENTION

The specific embodiments of the present invention are described below in greater detail. The following description of the specific embodiments refers at various places to the accompanying drawings and specific environments, applications, platforms, examples, computer screenshots, and implementations. Such description is provided for thorough understanding of the present invention and is illustrative rather than limiting.

According to the present invention, there is provided a system and method for spend analysis solution through strategies for mining spend information.

The system and method of the present invention aims to offer strategies for mining spend information. The key features of the system and method of this invention are as follows: built-in, standard category and supplier based savings strategies, easy creation of business constraints for data analysis, and creation of addressable spend definitions based on multiple parameters.

The major benefits being offered are as follows: start with actionable opportunities not just static spend reports, simplify the process of creating opportunity reports, and isolate and analyze datasets with high savings potential.

In accordance with an embodiment of the present invention, there is provided a classification system adapted to classify spend data in accordance with pre-determined parameters of classification. The system and method of the present invention works on classified spend data.

In accordance with another embodiment of the present invention, there is provided a categorization system adapted to categorize classified spend data based on pre-defined parameters.

In accordance with another embodiment of the present invention, there is provided an input system adapted to input pre-defined fields in relation to category of spend data, supplier information, payment terms, contracts or contract terms, and other pre-defined dimensions. The category includes category names and category classification. Suppliers include normalized vendors. Other dimensions include region, time, general ledger, business units, data source, and the like.

In accordance with another embodiment of the present invention, there is provided a saving strategy analysis engine adapted to analyze classified and categorized spend data based on pre-determined strategies. The saving strategy analysis engine comprises the following engines: category based saving strategy analysis engine to output saving strategy per identified category, and supplier based saving strategy analysis engine to output saving strategy per identified supplier.

Purchasing professionals could investigate spend data based on different strategies to find out saving opportunities. Depending on organizational structure and business processes, these strategies could be based on category, supplier, business unit, region, or pre-defined parameters.

In accordance with another embodiment of the present invention, there is provided a category based saving strategy engine adapted to provide saving strategies in relation to category inputs.

In accordance with another embodiment of the category based saving strategy engine of the present invention, there is provided a supplier consolidation saving strategy formulating system. This output elaborates savings achieved due to reducing supplier base to top suppliers. Consolidation of suppliers system reducing the number of suppliers that the organization deals with, for example by introducing a corporate contract with one supplier in place of contracts with several suppliers made by individual departments. The action/impact points include: leverage spend with suppliers, price negotiation lever, optimization of procurement practices, improvement of visibility across plants, and also depiction of estimated saving statistics that can be achieved by implementing the saving strategy in reality terms.

In accordance with another embodiment of the category based saving strategy engine of the present invention, there is provided a spend consolidation saving strategy formulating system. This output elaborates savings achieved due to aggregating demand from different business units. Consolidation of spend system bringing together the expenditure on particular goods and services incurred by individual departments of the organization, so that contracts can be created to cover the total expenditure for the goods and services. The action/impact points include: volume discounts and price negotiation, rationalization of demand, improvement of compliance, and reduction of overhead costs.

In accordance with another embodiment of the category based saving strategy engine of the present invention, there is provided a contract compliance saving strategy formulating system. This output elaborates savings achieved by reducing spend from off-contract. Contract compliance could ensure savings by tracking spend through contract. The action/impact points include: monitoring of contract leakages, improvement of process compliance across the organization, and increased contract visibility.

In accordance with another embodiment of the category based saving strategy engine of the present invention, there is provided a payment term rationalization strategy formulating system. This output elaborates savings achieved due to getting the best payment term from each supplier, e.g., a payment term rationalization system negotiating better payment terms with suppliers who are giving different payment terms. Savings could be realized in terms of increased accounts payable cash flow. The action/impact points include: optimization of procurement practices and negotiation leverage.

In accordance with another embodiment of the present invention, there is provided a supplier based saving strategy engine adapted to provide saving strategies in relation to supplier inputs.

In accordance with another embodiment of the supplier based saving strategy engine of the present invention, there is provided a region spread strategy formulating system adapted to provide a region spread strategy. This output elaborates savings achieved due to dealing with global suppliers.

In accordance with another embodiment of the supplier based saving strategy engine of the present invention, there is provided a category spread strategy formulating system adapted to provide a category spread strategy. This output elaborates savings achieved due to dealing with suppliers that provide higher number of categories.

In accordance with another embodiment of the supplier based saving strategy engine of the present invention, there is provided a payment term strategy formulating system adapted to provide a payment rationalization strategy. This output elaborates savings achieved by getting best payment terms from suppliers.

In accordance with an embodiment of the present invention, there is provided a scope determination system adapted to determine scope of each of spend data and each of the strategy engines depending upon pre-determined parameters of classification. There may be an addressable spend parameter that is an input and used by the scope determination system.

When a purchasing professional (e.g., a category manager as a user) starts looking for savings opportunity, he/she could first decide the scope of analysis for mining spend data. One of the reasons could be that he/she is responsible for specific category or region. These may become the actionable addressable spend for the respective users.

In accordance with another embodiment of the present invention, there is provided an unknown category addition system adapted to add categories in relation to spend data. The system and method of the present invention provides a capability to find out addressable spend by using different parameters.

For a category manager, the parameters could be region, geography, spend range, time period, general ledger (i.e., GL), and/or the like. Using a combination of these parameters, users can find the addressable spend. These parameters could be configurable as per pre-defined dimensions.

In accordance with another embodiment of the present invention, there is provided a known category addition system adapted to add categories in relation to spend data. If the user knows the spend category, he/she can directly select those as addressable spend. The user can search for their category using free text and the system could suggest the relevant category names. The user can also search from top categories or recent searches. The user could then add selected categories as their addressable spend.

In accordance with another embodiment of the present invention, there is provided a constraint parameter addition system adapted to add constraints and defined values/thresholds of each constraint parameter. The user could mine the spend data using different strategies on these addressable spends. The strategies could be changed by the user based on their requirements. The system and method of the present invention provides easy to use options to add business constraints using simple text definitions.

According to a non-limiting exemplary embodiment, the business constraint for different strategies based on category could be as follows:

1) Supplier Consolidation Strategy—to reduce the number of suppliers, the user needs to find out those categories where the top few suppliers are providing less than optimum spend.

a) Select categories where the supplier count is [more than/less than] [x] number.

b) Select categories where the top [y] [count] of suppliers are contributing [less than/more than] [z] % of total category spend.

2) Spend Consolidation—to consolidate spend across organization, the user needs to find out those categories that are procured in multiple business units.

a) Select categories that are procured in [more than/less than] [x] count of business units.

b) Select categories where [less than/more than] [y] % of spend is spread across the top [z] count of suppliers.

3) Contract Compliance—to ensure contract compliance, the user needs to find out those categories where spend from outside contract is high.

a) Select categories where [more than/less than] [x] % of spend is outside contract.

4) Payment Term Strategy—to get the best payment terms from suppliers, the user needs to find out those categories where the suppliers are asking for different payment terms.

Select categories where payment terms are different coming from the same suppliers.

The above text is presented in the application for a respective strategy. The user needs to select and enter only that information which is shown in brackets [ ]. Once the user defines the business constraint, he/she can schedule to run the report at any given time.

In accordance with another embodiment of this invention, there is provided a query formulation system adapted to formulate queries on sped data depending upon defined constraints in order to provide results.

Once the user defines the business constraint, it may be used as a query for backend processing. This query may be fired on the spend data set for the customer. The relevant result may be made available depending upon the business constraint defined by the user.

It is possible that there is no result found as a result of the query fired on the spend data set. This may be due to the reason that the business constraint that the user has fired is not resulting in any result.

In accordance with another embodiment of this invention, there is provided a report generation system adapted to generate reports of results in correlation with defined constraints and strategies. Reports for the business constraint applied are available. These reports present the required information that could help the user to take action based on the strategy that the user has selected. Reports are available in both tabular and graphical format. The information detail is as per the strategy selected.

The report presents savings number may be based on assumptions. These assumptions may be based on the applicant's experience on spend analysis and analyst findings. The user may change the assumption using “what if” analysis.

The report may have a list of categories that have matched the business constraints. The user may edit the report in probable status to manually select categories and move it to an identified status. Once the user is satisfied with the selection, he/she may mark the saving opportunity as finalized.

In another embodiment, the present invention provides a computer based method for spend analysis solution through strategies for mining spend information, the method comprising the steps of: classifying spend data in accordance with pre-determined parameters of classification; categorizing classified spend data based on pre-defined parameters; inputting pre-defined fields in relation to category of spend data, supplier information, payment terms, contracts or contract terms, and other pre-defined dimensions; and analyzing classified and categorized spend data based on pre-determined strategies, the analyzing method comprising the step of outputting saving strategy per identified inputs. In this method, the step of analyzing includes the step of outputting savings achieved due to dealing with suppliers that provide higher number of categories. In this method, the step of analyzing includes the step of outputting savings achieved by getting best payment terms from suppliers. This method includes the step of determining a scope of each of spend data and each of the strategy engines depending upon pre-determined parameters of classification. This method includes the step of adding categories in relation to spend data. This method includes the step of adding categories in relation to spend data. This method includes the step of adding constraints and defined values/threshold of each constraint parameter. This method includes the step of formulating queries on spend data depending upon defined constraints in order to provide results. This method includes the step of generating reports of results in correlation with defined constraints and strategies in order to have access and visibility of the saving opportunity strategies.

In accordance with another embodiment of the present invention, the flow of the above-described systems and methods will now be described.

The business process element consists of receiving input spend data via one or more input/output devices (e.g., cellular phone, smartphone, PDA, laptop computer, tablet computer, and/or any other like device that is selectively operable to communicate with the host computer system (or component thereof) through a wired and/or wireless connection).

A classification system is adapted to classify the input spend data in accordance with pre-determined parameters of classification and displaying the results in the classified format.

A categorization system is adapted to categorize classified spend data format based on pre-defined parameters and converting the classified spend data format into categorized spend data format.

A spend input system consisting of a second input/output device is adapted to input pre-defined fields in relation to category of spend data, supplier information, payment terms, contracts or contract terms, and other pre-defined dimensions.

A saving strategy analysis engine is adapted to analyze classified and categorized spend data format based on pre-determined strategies, wherein the saving strategy analysis engine is adapted to convert the input of classified and categorized spend data format into output through the second input/output device depicting the saving strategy per identified inputs.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for analyzing spend data by applying saving strategies, wherein there is an interconnection of at least one configurable and namable business process element, comprising:
a host computer system;
at least one database component operably associated with the host computer system;
a communication interface for accessing the host computer system from a plurality of remote input/output devices to manage the analysis of the spend data by applying saving strategies for the business process element;
wherein the business process element includes input spend data received from the remote input/output devices;
a processor unit operably associated with the host computer system; and
a computer readable medium storing instructions executable by the processor unit, the computer readable medium comprising:
a classification system adapted to classify the input spend data in accordance with pre-determined parameters of classification and display the results in a classified format;
a categorization system adapted to categorize the classified spend data format based on pre-defined parameters and convert the classified spend data format into a categorized spend data format;
a spend input system adapted to input pre-defined fields in relation to a category of spend data, supplier information, payment terms, contracts or contract terms; and
a saving strategy analysis engine adapted to analyze the classified and categorized spend data format based on pre-determined strategies, wherein the saving strategy analysis engine is further adapted to convert the input of classified and categorized spend data format into an output and depict a saving strategy according to the identified inputs.

2. The system as claimed in claim 1, wherein the saving strategy engine further comprises a supplier consolidation saving strategy formulating input system applied to classified and categorized spend data results and adapted to convert classified and categorized spend data results into output savings results achieved due to reducing supplier base to top suppliers.

3. The system as claimed in claim 1, wherein the saving strategy engine further comprises a spend consolidation saving strategy formulating input/output system applied to classified and categorized spend data results adapted to convert classified and categorized spend data results into output savings results achieved due to aggregating demand from different business units.

4. The system as claimed in claim 1, wherein, the saving strategy engine further comprises a contract compliance saving strategy formulating input/output system applied to classified and categorized spend data results adapted to convert classified and categorized spend data results into output savings results achieved by reducing spend from off-contract.

5. The system as claimed in claim 1 wherein, the saving strategy engine further comprises a payment term rationalization strategy formulating input/output system applied to classified and categorized spend data results adapted to convert classified and categorized spend data results into output savings achieved due to getting a best payment term from each supplier.

6. The system as claimed in claim 1, wherein the saving strategy engine further comprises a region spread strategy formulating input/output system applied to classified and categorized spend data results adapted to convert classified and categorized spend data results to provide a region spread strategy and to output savings results achieved due to dealing with a global supplier.

7. The system as claimed in claim 1, wherein the saving strategy engine further comprises a category spread strategy formulating input/output system applied to classified and categorized spend data results adapted to convert classified and categorized spend data results to provide a category spread strategy and to output savings results achieved due to dealing with a supplier that provides a higher number of categories.

8. The system as claimed in claim 1, wherein the saving strategy engine further comprises a payment term strategy formulating input/output system applied to classified and categorized spend data results adapted to convert classified and categorized spend data results to provide a payment rationalization strategy and to output savings results achieved by getting a best payment term from suppliers.

9. The system as claimed in claim 1, further comprising a scope determination system adapted to determine a scope of each of spend data and the strategy engine depending upon pre-determined parameters of classification.

10. The system as claimed in claim 1, further comprising an unknown category addition system adapted to add categories in relation to spend data.

11. The system as claimed in claim 1, further comprising a known category addition system adapted to add categories in relation to spend data.

12. The system as claimed in claim 1, further comprising a constraint parameter addition system adapted to add constraints and defined values/thresholds of each constraint parameter.

13. The system as claimed in claim 1, further comprising a query formulation system adapted to formulate queries on spend data depending upon defined constraints in order to provide results.

14. The system as claimed in claim 1, further comprising a report generation system adapted to generate reports of results in correlation with defined constraints and strategies in order to have access and visibility of the saving opportunity strategies.
